(19) United States
(12) Patent Application Publication
(10) Pub. No.: US 2013/0111818 A1
(43) Pub. Date: May 9, 2013

(54) DOOR OPENING/CLOSING STRUCTURE

(71) Applicants: Ryuuichi Yagi, Osaka-shi (JP); Takahisa Nagamine, Osaka-shi (JP); Masahiko Horizumi, Shizuoka-shi (JP)

(72) Inventors: Ryuuichi Yagi, Osaka-shi (JP); Takahisa Nagamine, Osaka-shi (JP); Masahiko Horizumi, Shizuoka-shi (JP)

(73) Assignee: YAGIKEN CO., LTD., Osaka-shi, Osaka (JP)

(21) Appl. No.: 13/808,963

(22) PCT Filed: Jul. 28, 2011
(86) PCT No.: PCT/JP2011/067351

§ 371 Date: Jan. 8, 2013

(30) Foreign Application Priority Data
Aug. 6, 2010 (JP) 2010-177729
Dec. 6, 2010 (JP) 2010-271939

(51) Int. Cl. E05D 7/00; E06B 7/28; E05D 15/00

(52) U.S. Cl. CPC E05D 7/00; E05D 15/00; E06B 7/28
USPC 49/397; 49/465

(57) ABSTRACT

Provided is a door opening/closing structure in which the attachment/detachment of the door is easy in the rotatably opening/closing door. In the door opening/closing structure, an axial member attached to a door and an axial member attached to an object to which the door is attached are arranged to oppose each other in at least one position of the rotatably fixed door, wherein one of the two axial members comprises a magnet and the other comprises a magnetic body or a magnet which attracts each other with the magnet.

### TECHNICAL FIELD

The present invention relates to a door opening/closing structure and more specifically, the present invention relates to an opening/closing structure of a door which opens/closes rotatably and is attached to buildings, furniture, ornaments and the like.

### BACKGROUND ART

Rotatably opening/closing doors have been widely used for buildings, furniture, ornaments and the like and many of the opening/closing structures of such doors have an opening/closing structure in which an axial member (convex portion) and a bearing (concave portion) are rotatably fixed in the concave-convex engagement. In Patent Document 1, the basic configuration of the door opening/closing structure also provides bearings in the center line of rotation at the door side and the main body side, which is an object to which the door is attached, and axial members rotatably engages in both bearings. However, these conventional door opening/closing structures are not intended for attachment/detachment of the door. Therefore, if the door is tried to be detached from the main body, it is not easy to attach and detach the door because of the interruption between the concavity and convexity of the axial members and the bearings.

Further, in Patent Document 2, the basic configuration is a concave-convex engagement fixation of a hinge axis (convex portion) and an engagement hole (concave portion), and there is proposed a hinge which is configured such that the hinge axis can be moved up and down and when the hinge axis comes close to the engagement hole, the hinge axis is protruded by the attraction of magnets provided in both of the hinge axis and the engagement hole, thereby the concave-convex engagement of the hinge axis and the engagement hole is achieved. However, this hinge is also included in a technique of fixing a door to an object to which the door is attached in the concave-convex engagement and if the door is tried to be detached from the main body, another means for releasing the concave-convex engagement fixation is required and thus the attachment/detachment of the door is not easy.

### PRIOR ART DOCUMENT

### Patent Document

Patent Document 1: Japanese Registered Utility Model No. 3160035
Patent Document 2: Japanese Unexamined Patent Publication 2002-021411

### SUMMARY OF THE INVENTION

### Problem to be Solved by the Invention

The present invention is made in the light of the above conventional problems and it is an object to provide a door opening/closing structure in which the attachment/detachment of the door is easy in the rotatably opening/closing door fixed to an object to which the door is attached by magnetic attraction.

### Means to Solve the Problem

The door opening/closing structure of the present invention is characterized in that an axial member attached to the door and an axial member attached to an object to which the door is attached are arranged to oppose each other in at least one position of the rotatably fixed door. In the above two axial members, one comprises a magnet and the other comprises a magnetic body or a magnet which attracts each other with the magnet.

The door opening/closing structure of the present invention is characterized in that an axial member attached to the door and an axial member attached to an object to which the door is attached are arranged to oppose each other in at least one end of the door rotatably fixed in the both ends. In the above two axial members, one comprises a magnet and the other comprises a magnetic body or a magnet which attracts each other with the magnet.

Moreover, it is preferable that the door is rotatably fixed to the object to which the door is attached by magnetic attraction and configured to be detachable from the object to which the door is attached against the magnetic attraction, from the state where the door and the object to which the door is attached are fixed.

Further, it is preferable that the axial member attached to the door is fixed to the door, the axial member attached to the object to which the door is attached is fixed to the object to which the door is attached and these two axial members are arranged to oppose each other in their end faces.

Further, it is preferable that at least one of the above two axial members is attached to the door or the object to which the door is attached to move along the axial direction.

Further, it is preferable to provide the door or the object to which the door is attached with an elastic body which biases the movably attached axial member in the opposite direction of the magnetic attraction direction.

Further, it is preferable that a skid is provided in at least one of the opposing faces of the above two axial members.

### Effect of the Invention

The present invention can fix a door to an object to which the door is attached not through a concave-convex engagement fixation but through magnetic attraction, preferably through magnetic attraction only. Therefore, in the state where the door and the object to which the door is attached are fixed by magnetic attraction, the door can be detached against the magnet attraction and thus the attachment/detachment of the door is easy. As a result, a purchaser himself can replace the door by other doors with different designs depending on the interior design or preference. In addition, since the door can be replaced by doors with other designs, there is no need to produce doors for each design and thus manufacturers can reduce the stock quantity. Therefore, the stock management becomes easy and the cost can be reduced. Moreover, since various designs can be taken in by only replacing doors, it is possible to drastically increase options of design. Furthermore, even if the door is broken, the replacement thereof is easy and thereby the cost burden on reparation can be reduced.

Moreover, in the door opening/closing structure in which the axial member is attached to the door or the object to which the door is attached to move along the axial direction, even if the case where a space is formed between the door and the object to which the door is attached and a space is formed between the opposing axial members, the movable axial member moves close to the opposing axial member by magnetic attraction depending on the space and preferably protrudes from the mounting surface thereof. Therefore, a rotatable fixation between the door and the object to which the door is attached through magnetic attraction can be ensured even for structures of different dimensional accuracies. For this reason, the rotatable fixation configuration via magnetic attraction can be easily applied to furniture having a certain degree of space between the door and the object to which the door is attached, without requiring high dimensional accuracy, for example. Here, this movable axial member is clearly different from conventional axial members since it is not the one moving along the axial direction for the engagement and release of the concave-convex engagement fixation, but is the one for carrying out the rotatable fixation by magnetic attraction. Furthermore, since the door can be detached from the object to which the door is attached against the magnetic attraction in the state where the door and the object to which the door is attached are fixed (in the state where the axial member is extracted by magnetic attraction and protrudes from the mounting surface thereof), the action of this axial member is substantially different from that of a conventional axial member which is configured movable on the premise of a concave-convex engagement fixation.

Further, in the door opening/closing structure in which an elastic body biasing a movable axial member in the opposite direction of the magnetic attraction direction is attached to the movable axial member, in the state where the door and the object to which the door is attached are not fixed, the movable axial member is biased to the side of the mounting surface thereof by the elastic body and preferably biased to the direction where the axial member does not protrude from the mounting surface thereof. Therefore, the axial member does not interrupt the attachment of the door. On the other hand, when the door is attached to the object to which the door is attached, the axial member moves towards the opposing axial member by magnetic attraction against the biasing force of the elastic body and preferably protrudes from the mounting surface thereof. Therefore, it becomes possible to easily and securely perform the rotatable fixation between the door and the object to which the door is attached through magnetic attraction.

Furthermore, by providing a skid on the facing surfaces of the axial member of the door and the axial member of the object to which the door is attached, friction resistance between the axial member of the door and the axial member of the object to which the door is attached is reduced and the door can be easily rotated and attached/detached.

### BRIEF DESCRIPTION OF THE DRAWINGS

FIG. 1 A schematic perspective view of furniture according to a first embodiment of the present invention.

FIG. 2 A schematic sectional view of a door opening/closing structure provided in the furniture of FIG. 1.

FIG. 3 A schematic perspective view of furniture according to a second embodiment of the present invention.

FIG. 4 A schematic sectional view of a door opening/closing structure provided in the furniture of FIG. 3 in the line X-X.

FIG. 5 A schematic sectional view of the door opening/closing structure provided in the furniture according to the third embodiment of the present invention and corresponding to FIG. 4.

FIG. 6 A schematic perspective view of furniture relating to a door opening/closing structure according to a forth embodiment of the present invention.

FIG. 7 A schematic sectional view of the door opening/closing structure provided in the furniture of FIG. 6.

FIG. 8 A schematic sectional view of an object to which a door is attached before the door is attached and corresponding to FIG. 7.

FIG. 9 A schematic sectional view of a door opening/closing structure according to a fifth embodiment of the present invention.

FIG. 10 A schematic sectional view of an object to which the door is attached before the door is attached and corresponding to FIG. 9.

### EMBODIMENT FOR CARRYING OUT THE INVENTION

The door opening/closing structure according to the embodiments of the present invention will be explained in detail referring to the drawings.

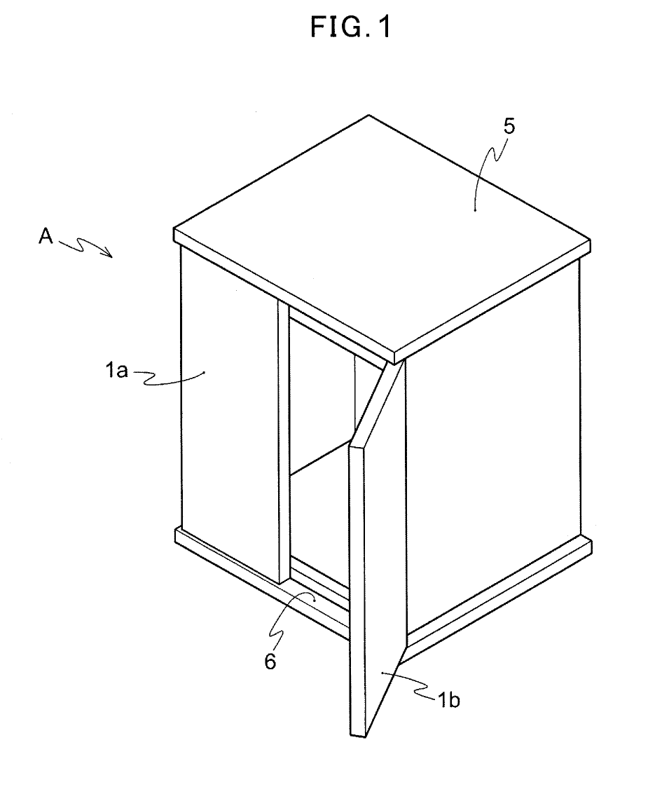

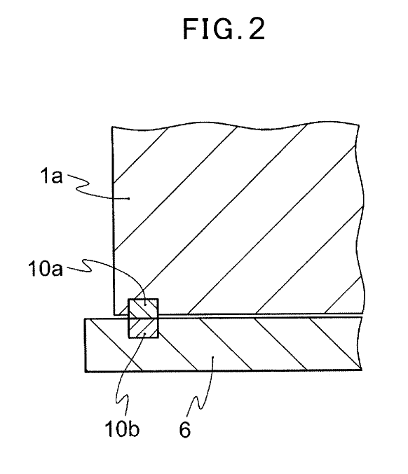

FIG. 1 is a schematic perspective view of furniture according to the first embodiment of the present invention and FIG. 2 is a schematic sectional view of a door opening/closing structure provided in the furniture of FIG. 1.

As shown in FIG. 1, the furniture A is a wooden structure in a box shape having a top plate 5 and a bottom plate 6, and three lateral sides are covered and almost all of the front surface is open. In the both sides of the front surface of the furniture A, a left-and-right pair of doors 1a and 1b which open and close in a gatefold manner are attached. The two doors 1a and 1b are a rectangular plate made of wood. The top and bottom of one side of the doors 1a and 1b are rotatably attached to the top plate 5 and the bottom plate 6 in a position anterior to the opening end of the front surface of the furniture A.

As shown in FIG. 2, in the bottom end of the door 1a, a cylindrical axial member (hereinafter, referred to as “first axial member”) 10a is fixed by embedding so as to become approximately the same plane with the bottom surface of the door 1a and slightly protrude therefrom. On the other hand, in the top surface of the bottom plane 6 that is a member of the object to which the door is attached, a cylindrical axial member (hereinafter, referred to as “second axial member”) 10b is fixed by embedding in a position opposing to the first axial member 10a so as to become approximately the same plane with the top surface of the bottom plate 6. Because of this, the first axial member 10a and the second axial member 10b are not exposed to exterior and thus do not influence the appearance. In addition, the above fixation is performed by fitting or with pins, screws or an adhesive.

The first axial member 10a comprises magnet and the second axial member 10b is iron. Because of this, the first axial member 10a and the second axial member 10b attract each other and the door 1a is rotatably fixed on the bottom plate 6. In this regard, though the types of magnets are not limited particularly, it is preferable to use permanent magnets such as a ferrite magnet or a neodymium magnet, which are easy to handle. The second axial member is not limited to iron and a magnetic body or a ferromagnetic body such as martensitic stainless steel can be also used.

The first axial member 10a and the second axial member 10b are arranged such that the bottom surface of the first axial member 10a and the top surface of the second axial member 10b, i.e. the end surfaces of the axial members 10a and 10b are opposed to each other. The both opposing surfaces are flat and a concave portion is not formed. The bottom surface of the top plate 5 and the top surface of the door 1a are also flat and thus a concavity and convexity for concave-convex engagement fixation of the door 1a is not formed. Additionally, both of the above opposing surfaces are a smooth surface. Because of this, friction resistance due to a contact between the first axial member 10a and the second axial member 10b is reduced, thereby the rotation of the door 1a and the attachment/detachment of the door 1a from the furniture A can be easily performed. Further, though a rotatable fixation at the top end of the door 1a is achieved with a publicly known bearing, the structure at the top end of the door 1a can be achieved with the above described structure used in the bottom end of the door 1a. Since the configuration of the door opening/closing structure in the door 1b is basically the same as the one used in the door 1a, the explanation thereof will be omitted.

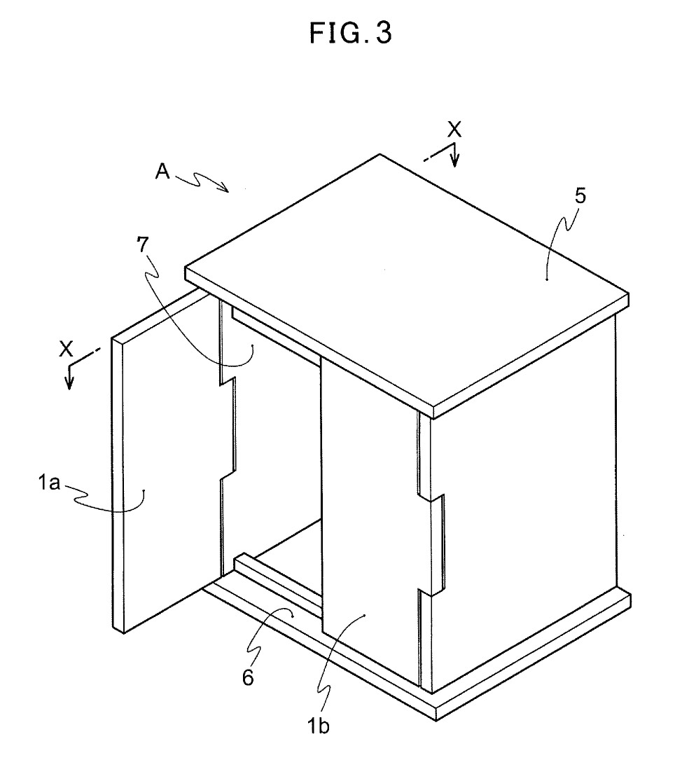

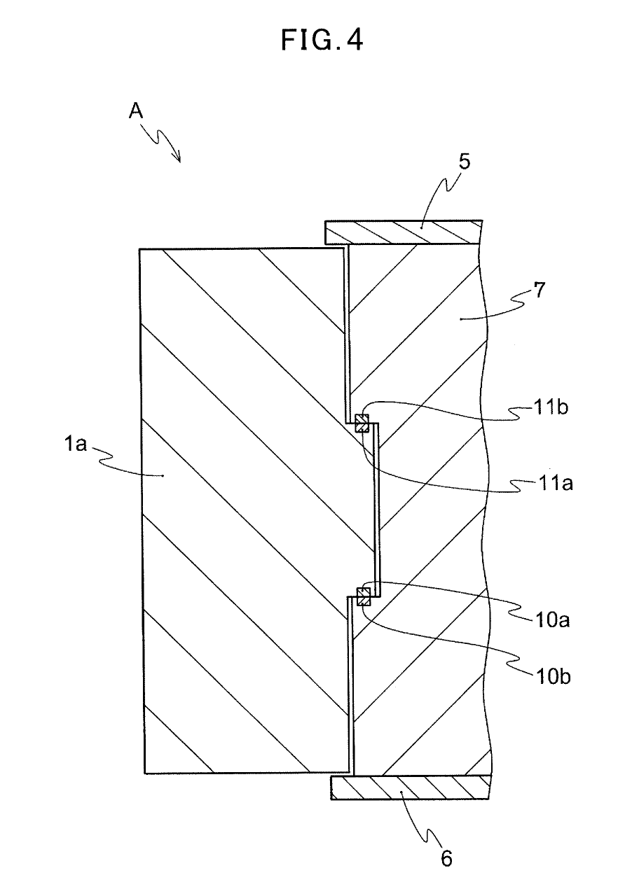

FIG. 3 is a schematic perspective view of furniture according to the second embodiment of the present invention and FIG. 4 is a schematic sectional view of a door opening/closing structure provided in the furniture of FIG. 3 in the line X-X. Since the configuration of the door opening/closing structure according to this embodiment is basically the same as that according to the first embodiment which is explained above, the explanation will be focused on differences therebetween.

As shown in FIGS. 3 and 4, the door 1a according to the second embodiment is different from that according to the first embodiment in that the end surface at the opening surface side of the side wall 7 of the furniture A is concavely notched and a convex portion formed in the door 1a at the fixation end of the door 1a is inserted into the notch, and in that axial members 10a and 11a are fixed by embedding in the bottom end and the top end of the convex portion and axial members 10b and 11b are fixed by embedding in a position corresponding to the axial members 10a and 11a in the notch of the side wall 7. Moreover, spaces are provided between the door 1a and the vertical surfaces of the side wall 7 and between the convex portion and the notch such that the door 1a can rotate. This configuration also enables a door to be detached against magnetic attraction, since the door 1a is rotatably fixed to the side wall 7 to which the door is attached through magnetic attraction.

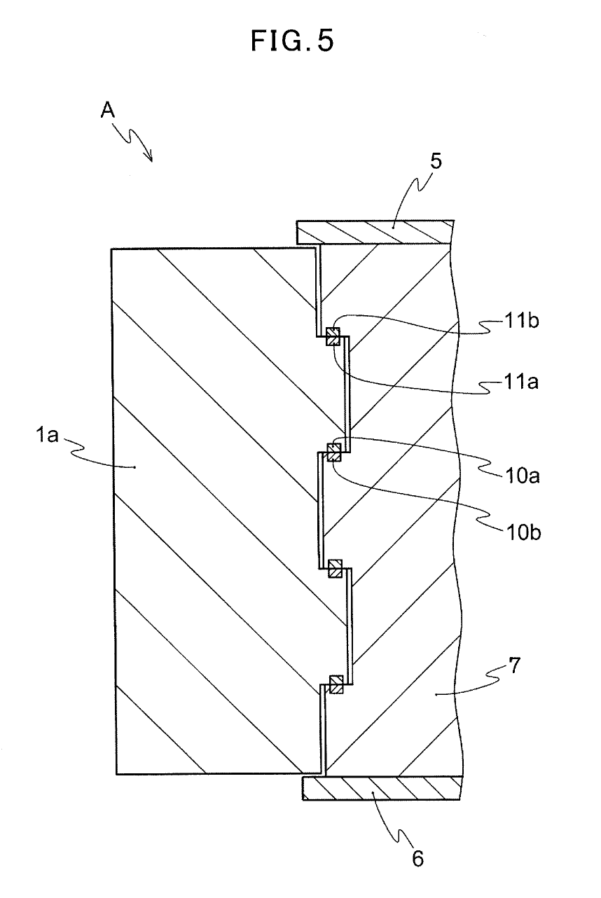

FIG. 5 is a schematic sectional view of the door opening/closing structure provided in the furniture according to the third embodiment of the present invention and corresponds to FIG. 4. Since the configuration of the door opening/closing structure according to this embodiment is basically the same as that according to the second embodiment which is explained above, the explanation will be focused on differences therebetween.

As shown in FIG. 5, the door 1a according to the third embodiment is different from that according to the second embodiment in that a plurality of (two) notches are formed at the upper side and lower side of the side wall at the opening surface side and a plurality of (two) convex portions are formed in the door 1a at the fixation end of the door 1a so as to correspond to the notches. This configuration also enables a door to be detached against magnetic attraction, since the door 1a is rotatably fixed to the side wall 7 to which the door is attached through magnetic attraction.

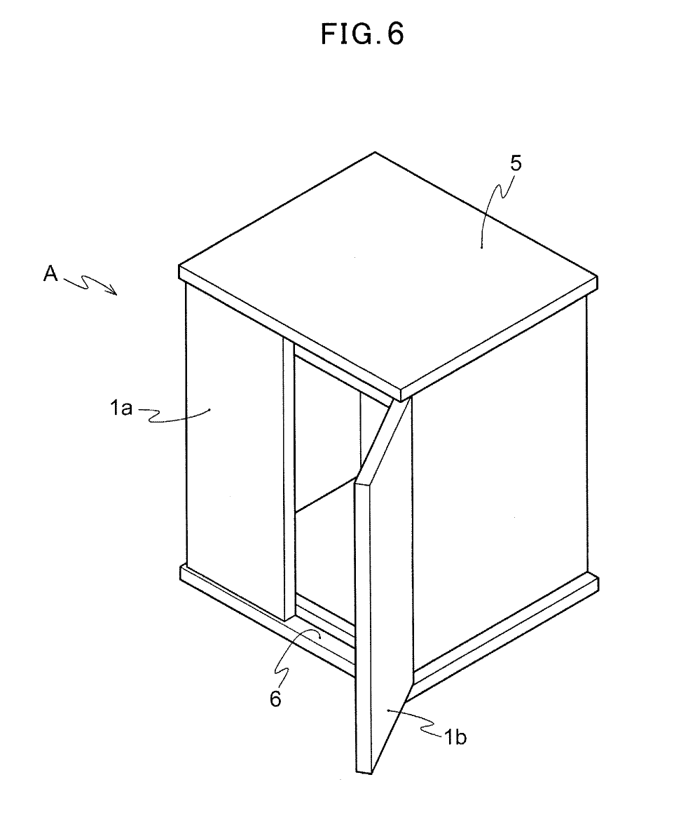

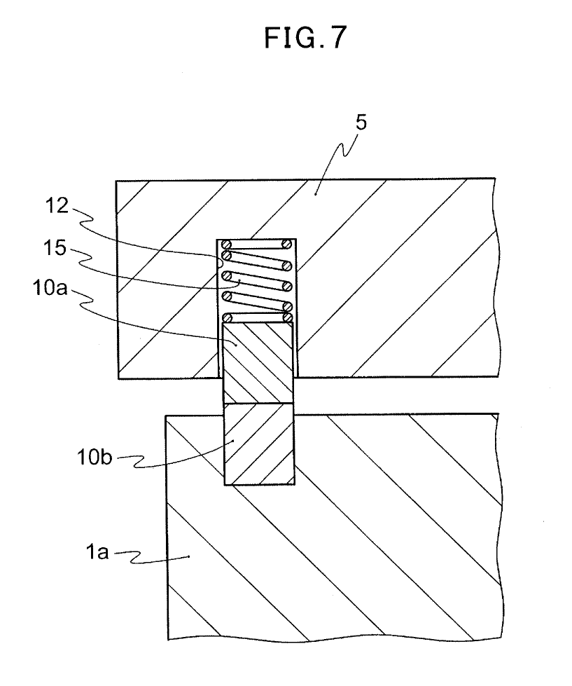

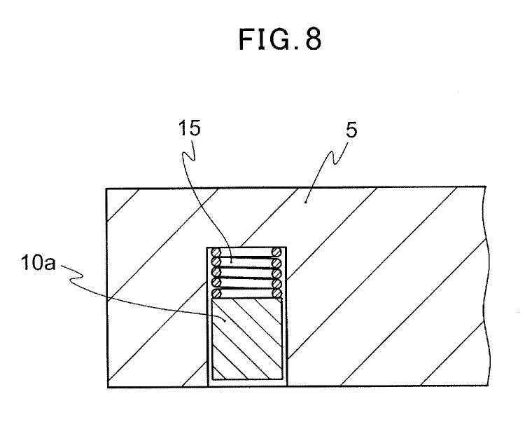

FIG. 6 is a schematic perspective view of furniture relating to a door opening/closing structure according to the forth embodiment of the present invention; FIG. 7 is a schematic sectional view of the door opening/closing structure provided in the furniture of FIG. 6; and FIG. 8 corresponds to FIG. 7 and is a schematic sectional view of an object to which a door is attached before the door is attached.

As shown in FIG. 6, furniture A provided with a door opening/closing structure according to the forth embodiment is a wooden structure in a box shape having a top plate 5 and a bottom plate 6, and three lateral sides are covered and almost all of the front surface is open. In the both sides of the front surface of the furniture A, a left-and-right pair of doors 1a and 1b which open and close in a gatefold manner are attached. The two doors 1a and 1b are a rectangular plate made of wood. The top and bottom of one side of the doors 1a and 1b are rotatably attached to the top plate 5 and the bottom plate 6 in a position anterior to the opening end of the front surface of the furniture A.

As shown in FIG. 7, in the bottom surface of a top plate 5 that is a member of the object to which the door 1a is attached, a cylindrical axial member (hereinafter, referred to as “first axial member”) 10a is embedded in a concave portion 12 formed on the bottom surface of the top plate 5 and the bottom end of first axial member 10a protrudes downward from the bottom surface of the top plate 5. On the other hand, in the top edge of the door 1a, a cylindrical axial member (hereinafter, referred to as “second axial member”) 10b is fixed by embedding in a position opposing to the first axial member 10a so as to become approximately the same plane with the top surface of the door 1a and slightly protrude therefrom.

The first axial member 10a is iron and the second axial member 10b comprises magnet. Thereby the first axial member 10a is attracted by the second axial member 10b and this magnetic attraction rotatably fixes the door 1a to the top plate 5. Here, the first axial member is not limited to iron and a magnetic body or a ferromagnetic body such as martensitic stainless steel can be also used. Though the types of magnets are not limited particularly either, it is preferable to use permanent magnets such as a ferrite magnet or a neodymium magnet, which are easy to handle.

Moreover, the first axial member 10a is attached to the top plate 5 via a spring 15 as an elastic body. Because of this, the first axial member 10a becomes movable along the axial direction within the range of expansion and contraction of the spring 15 and slides in the concave portion 12. The spring 15 biases the first axial member 10a to the opposite direction of the magnetic attraction direction, that is, toward the direction of the top plate 5 which is the direction where the first axial member 10a does not protrude from the bottom surface of the top plate 5. Because of this, as shown in FIG. 8, the bottom end of the first axial member 10a does not protrude from the bottom surface of the top plate 5 and becomes approximately the same plane with the bottom surface of the top plate 5 before the door 1a is fixed, thereby does not become impeditive. On the other hand, when the door 1a is fixed to the furniture A, as shown in FIG. 7, the first axial member 10a moves toward the opposite second axial member 10b by magnetic attraction against the biasing force of the spring 15 and abuts on the second axial member 10b. As a result, even if a space is formed between the door 1a and the furniture A, the first axial member 10a moves for a distance only between the first axial member 10a and the second axial member 10b and thus the rotatable fixation can be ensured. The elastic body is not limited to a spring and a rubber or sponge can be also used. Additionally, the fixation of the second axial member is performed by fitting or with pins, screws or adhesive.

The bottom surface of the first axial member 10a and the top surface of the second axial member 10b, i.e. the opposing surfaces of the axial members are both flat and a concave portion is not formed. The bottom surface of the top plate 5 and the top surface of the door 1a are also flat and a concavity and convexity for concave-convex engagement fixation of the door 1a is not formed. Additionally, both of the above described opposing surfaces are a smooth surface and thereby friction resistance due to a contact between the axial members is reduced and the rotation of the door 1a and the attachment/detachment of the door 1a from the furniture A can be easily performed.

On the other hand, though a rotatable fixation at the bottom end of the door 1a is achieved with a publicly known bearing, the structure at the bottom end of the door 1a can be achieved with the above described structure used in the top end of the door 1a. Additionally, since the configuration of the door opening/closing structure in the door 1b is basically the same as the one used in the door 1a, the explanation thereof will be omitted.

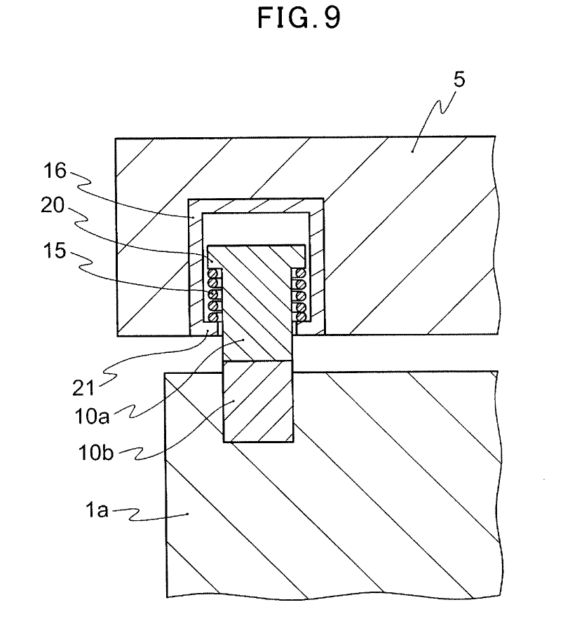

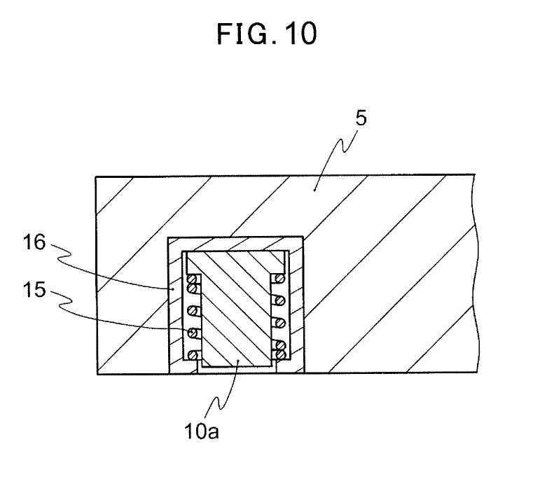

FIG. 9 is a schematic sectional view of a door opening/closing structure according to the fifth embodiment of the present invention; and FIG. 10 corresponds to FIG. 9 and is a schematic sectional view of the object to which the door is attached before the door is attached. Since the configuration of the door opening/closing structure according to this embodiment is basically the same as that according to the forth embodiment which is explained above, the explanation will be focused on differences therebetween.

As shown in FIGS. 9 and 10, the door 1a according to the fifth embodiment is different from that according to the forth embodiment in that a flange 20 is formed on the upper side of a first axial member 10a over the outer circumference and the first axial member 10a has a T-shaped longitudinal section, and that a casing 16 is fixed by embedding in a concave portion formed on the bottom surface of the top plate 5 and a compression spring 15 and the first axial member 10a are contained in the casing 16.

The casing 16 is a member with a cylindrical shape and contains the first axial member 10a and the spring 15 in a hollow portion thereof. On the bottom surface of the casing 16, a protrusion 21 extending toward the center of the casing 16 is formed over the circumference thereof, and an opening with a diameter which is larger than the outer circumference of the body of the axial member 10a and smaller than the outer circumference of the flange 20 of the axial member 10a is formed inside the protrusion 21. In the casing 16, as shown in FIG. 9, the spring 15 is rested on the protrusion 21 and the bottom end of the first axial member 10a is inserted into the opening on the bottom surface of the casing 16 via the spring 15 and the casing 16 is configured such that the spring 15 is sandwiched between the flange 20 of the first axial member 10a and the protrusion 21 of the casing 16. The casing 16 configured in this manner is fixed by embedding in the concave portion of the top plate 5 such that the opening side thereof is positioned on the bottom surface of the top plate 5. With this configuration, the first axial member 10a is also biased by the spring 15 to the opposite direction of the magnetic attraction direction, that is, the direction where the first axial member 10a does not protrude from the bottom surface of the top plate 5. Because of this, as shown in FIG. 10, the bottom end of the first axial member 10a does not protrude from the bottom surface of the top plate 5 and becomes approximately the same plane with the bottom surface of the top plate 5 before the door 1a is fixed, thereby the first axial member 10a does not become impeditive. On the other hand, when the door 1a is fixed to the furniture A, as shown in FIG. 9, the first axial member 10a moves toward the opposite second axial member 10b by magnetic attraction against the biasing force of the spring 15 and abuts on the second axial member 10b. As a result, even if a space is formed between the door 1a and the furniture A, the first axial member 10a moves for a distance only between the first axial member 10a and the second axial member 10b and thus the rotatable fixation can be ensured. Here, the material of the casing 16 is not limited and a non-magnetic metal, a synthetic resin and wood can be used.

As described above, according to the door opening/closing structure of the above embodiments of the present invention, the fixation between the door and the object to which the door is attached can be performed by magnetic attraction. Therefore, the door can be easily detached against the magnetic attraction from the state where the door and the object to which the door is attached are fixed by magnetic attraction, and thereby the attachment/detachment of the door is easy. Moreover, in the door opening/closing structures according to the forth and fifth embodiments, one axial member is configured to be movable along the axial direction. Therefore, even if a space is formed between the door and the object to which the door is attached, one axial member can move close to the opposing other axial member by magnetic attraction and abut thereon, depending on a distance of the space. As a result, the structure of the rotatable fixation due to magnetic attraction of the present invention can be also applied to millwork having a large dimensional tolerance such as furniture and a rotatable fixation between the door and the object to which the door is attached can be ensured even for structures of different dimensional accuracies. Further, by attaching an elastic body which biases the axial member to the opposite direction of the magnetic attraction direction, in the state where the door and the object to which the door is attached are not fixed, the axial member is biased to the direction where the axial member does not protrude from the mounting surface thereof, and thereby does not become impeditive. On the other hand, in the state where the door and the object to which the door is attached are fixed, the axial member moves to the opposing axial member and abuts thereon by magnetic attraction against the biasing force of the elastic body. As a result, the rotatable fixation between the door and the object to which the door is attached can be performed easily and certainly.

It should be noted that though the object to which the door is attached is furniture in the above embodiment, the present invention is not limited thereto and can be widely applied to boxes, buildings, or electronic devices. Also, opening/closing doors are not limited to a left-and-right pair of doors or a single door and can be also applied to a swing door opening/closing up and down and a lid-shaped swing door, and further applied to a door consisting of three or more doors. Moreover, the opening/closing includes a partial opening/closing and the state where a door is half-open. Doors are not limited to wooden doors as long as doors are made from a non-magnetic material, and doors may be made from a synthetic resin or aluminum.

Moreover, though the door opening/closing structure of the present invention is provided at one of the top side or bottom side of the door, the present invention is not limited thereto and door opening/closing structures of different embodiments may be appropriately combined and provided at each of both ends of the door. In addition, the rotational axis of the door is not limited to the longitudinal direction and in the case where the door opening/closing structure of the present invention is applied to a swing door opening/closing up and down or a lid-shaped swing door in which the rotational axis is horizontal, the door opening/closing structure can be provided at one or both of the both ends of the door. Additionally, the same applies to the case where the rotational axis of the door is inclined. It is also possible to apply the door opening/closing structure of the present invention to the rotational axis of a hinge which is attached to the door. The fixation of the axial member is not limited to a fixation by embedding in the door or object to which the door is attached and the axial member can be also attached externally.

Further, in the above embodiment, though the axial member is arranged so as to become approximately the same plane with the mounted surface thereof, the present invention is not limited thereto and the axial member may be arranged so as to protrude from the mounted surface thereof, or arranged so as not to protrude from the mounted surface but become the same plane with the mounted surface or dent from the mounted surface. Additionally, the axial member is not limited to the one embedded into a door or an object to which the door is attached, and the axial member can also be attached externally on the door or the object to which the door is attached.

Furthermore, though the shape of the axial member is cylindrical in the above embodiments, the shape of the axial member is not limited thereto and may be horn-shaped, spherical or flat, and as for a material of the axial member, a magnet can be used for the both axial members. In that case, the axial members are arranged such that the magnetic poles at the opposing ends of the two axial members are different. Further, the axial member is not limited to the one consisting of a magnet only or the one consisting of a magnetic body only, and a member comprising a magnet or magnetic body may be used. An example of such member is a casing containing a magnet or a molding consisting of a synthetic resin comprising a mixture of a magnet or magnetic body formed into particles.

Furthermore, though a smooth surface is formed on the axial member of the door and the axial member of the object to which the door is attached in the above embodiment, the smooth surface may be formed by polishing by use of an abrasive. Additionally, in order to reduce friction resistance due to a contact between the axial member of the door and the axial member of the object to which the door is attached, it is preferable that a skid is provided in at least one of the opposing faces of the axial member of the door and the axial member of the object to which the door is attached. Examples of a skid include a plating such as nickel-plating, a coating comprising a synthetic resin coating such as a Teflon (registered trademark) coating, a sheet member comprising a hard synthetic resin such as DURACON (registered trademark) or a rubber, a wooden plate, paper on which a synthetic resin is coated and lubricant oil. The thickness of these skids is not limited as long as it does not drastically deteriorate the force of attraction of the axial member of the door and the axial member of the object to which the door is attached. It is better that the thickness is as thinner as possible and preferably not more than 2 mm. The sheet member, wooden plate or coated paper can be fixed to the axial member with an adhesive. It goes without saying that the contact and abutment between the opposing surfaces of the axial members of the present invention include a contact and abutment via the above skid.

Furthermore, though the door is rotatably fixed to the side wall of furniture in the second and third embodiments, the present invention is not limited thereto and the door opening/closing structure of the present invention can be adopted when one door and another door are rotatably fixed. In that case, the object to be attached of one door is the other door.

Furthermore, though the movable axial member is attached to furniture that is an object to which the door is attached in the above forth and fifth embodiments, the present invention is not limited thereto and the movable axial member may be attached to the door or both of the door and the object to which the door is attached.

### EXPLANATION OF SYMBOLS

A Furniture
1, 1a, 1b Door
5 Top plate
6 Bottom plate
7 Side wall
10a (First) axial member
10b (Second) axial member
11a, 11b Axial member
12 Concave portion
15 Spring
16 Casing
20 Flange
21 Protrusion

1. A door opening/closing structure configured such that an axial member attached to a door and an axial member attached to an object to which the door is attached are arranged to oppose each other in at least one position of the rotatably fixed door, wherein one of the two axial members comprises a magnet and the other comprises a magnetic body or a magnet which attracts each other with the magnet.

2. A door opening/closing structure configured such that an axial member attached to a door and an axial member attached to an object to which the door is attached are arranged to oppose each other in at least one end of the door rotatably fixed in the both ends, wherein one of the two axial members comprises a magnet and the other comprises a magnetic body or a magnet which attracts each other with the magnet.

3. The door opening/closing structure according to claim 1, wherein the door is rotatably fixed to the object to which the door is attached by magnetic attraction and configured to be detachable from the object to which the door is attached against the magnetic attraction from the state where the door and the object to which the door is attached are fixed.

4. The door opening/closing structure according to claim 3, wherein the axial member attached to the door is fixed to the door, the axial member attached to the object to which the door is attached is fixed to the object to which the door is attached and the two axial members are arranged to oppose each other in their end surfaces.

5. The door opening/closing structure according to claim 3, wherein at least one of the two axial members is attached to the door or the object to which the door is attached so as to move along the axial direction.

6. The door opening/closing structure according to claim 4 comprising an elastic body which biases the movably attached axial member in the opposite direction of the magnetic attraction direction.

7. The door opening/closing structure according to claim 1, wherein a skid is provided in at least one of the opposing faces of the two axial members.

8. The door opening/closing structure according to claim 2, wherein the door is rotatably fixed to the object to which the door is attached by magnetic attraction and configured to be detachable from the object to which the door is attached against the magnetic attraction from the state where the door and the object to which the door is attached are fixed.

9. The door opening/closing structure according to claim 8, wherein the axial member attached to the door is fixed to the door, the axial member attached to the object to which the door is attached is fixed to the object to which the door is attached and the two axial members are arranged to oppose each other in their end surfaces.

10. The door opening/closing structure according to claim 8, wherein at least one of the two axial members is attached to the door or the object to which the door is attached so as to move along the axial direction.

11. The door opening/closing structure according to claim 10 comprising an elastic body which biases the movably attached axial member in the opposite direction of the magnetic attraction direction.

12. The door opening/closing structure according to claim 2, wherein a skid is provided in at least one of the opposing faces of the two axial members.

13. The door opening/closing structure according to claim 3, wherein a skid is provided in at least one of the opposing faces of the two axial members.

14. The door opening/closing structure according to claim 4, wherein a skid is provided in at least one of the opposing faces of the two axial members.

15. The door opening/closing structure according to claim 5, wherein a skid is provided in at least one of the opposing faces of the two axial members.

16. The door opening/closing structure according to claim 6, wherein a skid is provided in at least one of the opposing faces of the two axial members.

17. The door opening/closing structure according to claim 8, wherein a skid is provided in at least one of the opposing faces of the two axial members.

18. The door opening/closing structure according to claim 9, wherein a skid is provided in at least one of the opposing faces of the two axial members.

19. The door opening/closing structure according to claim 10, wherein a skid is provided in at least one of the opposing faces of the two axial members.

20. The door opening/closing structure according to claim 11, wherein a skid is provided in at least one of the opposing faces of the two axial members.
